(19) United States
(12) Patent Application Publication
(10) Pub. No.: US 2021/0404257 A1
(43) Pub. Date: Dec. 30, 2021

(54) APPARATUS, SYSTEMS, AND METHODS FOR A REINFORCED SEAL ELEMENT FOR JOINTS ON A DRILLING TOOL

(71) Applicant: National Oilwell DHT, L.P., Conroe, TX (US)

(72) Inventors: Choosiang Wong, Pearland, TX (US); Steve S. Bhagwandin, Houston, TX (US); Angel Jose Marcucci, Houston, TX (US)

(73) Assignee: National Oilwell DHT, L.P., Conroe, TX (US)

(21) Appl. No.: 17/290,345

(22) PCT Filed: Oct. 31, 2019
(86) PCT No.: PCT/US2019/059130

§ 371 Date: Apr. 30, 2021

Related U.S. Application Data
(60) Provisional application No. 62/753,889, filed on Oct. 31, 2018.
(60) Provisional application No. 62/877,555, filed on Jul. 23, 2019.

(51) Int. Cl. E21B 4/00; E21B 17/02; F16J 15/328; B29C 43/18; B29C 45/14; B29C 43/52; B32B 5/02; B32B 1/08; B32B 25/10; B32B 37/10; B32B 37/18; B32B 37/15

(52) U.S. Cl. CPC E21B 4/003; B29L 2031/26; F16J 15/328; B29C 43/18; B29C 45/14008; B29C 45/14311; B29C 45/14786; B29C 45/14491; B29C 43/52; B32B 5/02; B32B 1/08; B32B 25/10; B32B 37/10; B32B 37/18; B32B 37/15; B29C 2043/189; E21B 17/02

(57) ABSTRACT

A method for forming a seal boot includes forming a stack of discrete, non-intertwined layers by layering a sheet of elastomeric material with a fabric; rolling the stack to form a tube; installing the tube within a mold; closing the mold; and heating the mold and the installed tube.

### CROSS-REFERENCE TO RELATED APPLICATIONS

The present application claims benefit of U.S. provisional patent application No. 62/753,889 filed Oct. 31, 2018, entitled “Apparatus, Systems, and Methods for a Reinforced Joint Seal Element on a Drilling Tool Assembly” and U.S. provisional patent application No. 62/877,555 filed Jul. 23, 2019, entitled “Apparatus, Systems, and Methods for a Reinforced Joint Seal Element on a Drilling Tool Assembly,” both of which are incorporated herein by reference in their entirety.

### STATEMENT REGARDING FEDERALLY SPONSORED RESEARCH OR DEVELOPMENT

Not applicable.

### BACKGROUND

### Field of the Disclosure

This disclosure relates generally to tools for drilling hydrocarbon or other types of wells. More particularly, it relates to a bottom hole assembly. Still more particularly, this disclosure relates to a bottom hole assembly having fluid seals.

### Background to the Disclosure

A properly configured bottom hole assembly (BHA) is the lower portion of the drill string for creating or extending a wellbore for a hydrocarbon or other type of well. A BHA usually consists of a drill bit, drilling motor, drill collar, subs like a reamer, a stabilizer, a shock tool, and other specialized drilling or directional tools. The drilling motor is the main component to provide additional power to the drill bit while drilling. A drilling motor comprises a power section, a driveshaft assembly, and a bearing assembly. The bearing assembly includes a mandrel having an end configured to couple to a drill bit.

The power section includes a tubular housing and a mud motor having a stator and a rotor held in the housing. The power section provides a wide range of rotational speeds and torque outputs to the bit. The rotational speed is proportional to the rate of drilling fluid passing through the power section, and the torque output is proportional to the differential pressure of that fluid. The power section may be, for example, a progressive cavity positive displacement pump. When the drilling fluid is pumped through the power section, it creates a powerful eccentric motion (eccentric relative to the housing) in the rotor.

The driveshaft assembly includes a driveshaft and two lubricated and sealed joints (examples include: universal, constant velocity, flex coupling, or any suitable coupling assembly) enclosed in an adjustable bent-housing or fixed bent-housing, which connects to the housing of the power section. The driveshaft and its joints couple the rotor to the bearing assembly. One of the sealed joints is located between the driveshaft and the power section. The other seal joint is located between the driveshaft and the bearing assembly. The driveshaft assembly performs as a transmission section to convert and transmit the eccentric power from the rotor to concentric power in the bearing assembly and ultimately in the drill bit. Facilitated by the joints, the driveshaft assembly adapts to any angle that is set or established in the adjustable/fixed bent-housing, and transmits the thrust load from the rotor that is generated by the pressure drop across the power section. The driveshaft assembly is designed to withstand the torque developed by the power section.

The bearing assembly consists of bearing pack, bearing stack, and mandrel. A bearing assembly is used to transmit the rotation of the driveshaft assembly to the drill bit. The bearing assembly is designed to carry the thrust load from the weight of the collars, as well as the radial and bending loads that develop during directional or steerable drilling.

### SUMMARY

In accordance with at least one example of the disclosure, a method for forming a seal boot includes forming a stack of discrete, non-intertwined layers by layering a sheet of elastomeric material with a fabric; rolling the stack to form a tube; installing the tube within a mold; closing the mold; and heating the mold and the installed tube.

In accordance with another example of the disclosure, a seal boot for a rotatable joint of a downhole tool includes a first body layer bonded to a first fabric layer, forming a generally tubular body that extends along a sleeve axis between a first end and a second end, and that extends radially between an inner surface and an outer surface. The seal boot is configured to cover the rotatable joint of the downhole tool.

### BRIEF DESCRIPTION OF THE DRAWINGS

For a detailed description of the disclosed exemplary embodiments, reference will now be made to the accompanying drawings, wherein:

FIG. 1a shows a downhole drilling tool assembly that includes a drilling motor with fabric reinforced seal elements installed on universal joints, in accordance with principles described herein;

FIG. 1b shows a close view of a reinforced seal boot installed on a universal joint of the drilling motor of Fig la;

FIGS. 2a, 2b, and 2c show various views of a triple-ply fabric reinforced seal element, which includes three, spaced-apart fabric layers located at outer, mid-region, and inner radial locations in relation to body material, in accordance with principles described herein;

FIG. 3 shows an axial sectional view of a double-ply fabric reinforced seal element, which includes two spaced-apart fabric layers located at outer and inner radial locations in relation to body material, in accordance with principles described herein;

FIG. 4 shows an axial sectional view of a double-ply fabric reinforced seal element, which includes two spaced-apart fabric layers located at outer and mid-region radial locations in relation to body material, in accordance with principles described herein;

FIG. 5 shows an axial sectional view of a double-ply fabric reinforced seal element, which includes two spaced-apart fabric layers located at inner and mid-region radial locations in relation to body material, in accordance with principles described herein;

FIG. 6 shows a sectional view of a single-ply fabric reinforced seal element, which includes a fabric layer located an outer radial location, in accordance with principles described herein;

FIG. 7 shows an axial sectional view of a single-ply fabric reinforced seal element, which includes a fabric layer embedded within body material of the seal element, in accordance with principles described herein;

FIG. 8 shows an axial sectional view of a single-ply fabric reinforced seal element, which includes a fabric layer located an inner radial location, in accordance with principles described herein;

FIG. 9 shows a sectional view of a representative mold for compression molding to produce a fabric reinforced seal boot in accordance with principles described herein. In this example, the boot of FIG. 3 is being molded;

FIG. 10 is the representative figure of injection molding to produce the fabric reinforced seal boot in accordance with principles described herein. In this example, the boot of FIG. 3 is being molded; and

FIG. 11 shows a diagram of a method for producing a reinforced seal boot, in accordance with principles described herein.

### NOTATION AND NOMENCLATURE

The following description is exemplary of certain embodiments of the disclosure. One of ordinary skill in the art will understand that the following description has broad application, and the discussion of any embodiment is meant to be exemplary of that embodiment, and is not intended to suggest in any way that the scope of the disclosure, including the claims, is limited to that embodiment.

The figures are not drawn to-scale. Certain features and components disclosed herein may be shown exaggerated in scale or in somewhat schematic form, and some details of certain elements may not be shown in the interest of clarity and conciseness. In some of the figures, in order to improve clarity and conciseness, one or more components or aspects of a component may be omitted or may not have reference numerals identifying the features or components. In addition, within the specification, including the drawings, like or identical reference numerals may be used to identify common or similar elements.

As used herein, including in the claims, the terms “including” and “comprising,” as well as derivations of these, are used in an open-ended fashion, and thus are to be interpreted to mean “including, but not limited to . . . ” Also, the term “couple” or “couples” means either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, then X may be based on Y and on any number of other factors. The word “or” is used in an inclusive manner. For example, “A or B” means any of the following: “A” alone, “B” alone, or both “A” and “B.” In addition, the word “substantially” means within a range of plus or minus 10%.

In addition, the terms “axial” and “axially” generally mean along or parallel to a given axis, while the terms “radial” and “radially” generally mean perpendicular to the axis. For instance, an axial distance refers to a distance measured along or parallel to a given axis, and a radial distance means a distance measured perpendicular to the axis. Furthermore, any reference to a relative direction or relative position is made for purpose of clarity, with examples including “top,” “bottom,” “up,” “upper,” “upward,” “down,” “lower,” “clockwise,” “left,” “leftward,” “right,” and “right-hand.” For example, a relative direction or a relative position of an object or feature may pertain to the orientation as shown in a figure or as described. If the object or feature were viewed from another orientation or were implemented in another orientation, it may then be helpful to describe the direction or position using an alternate term.

### DETAILED DESCRIPTION

According to examples of this disclosure, the driveshaft assembly described above is also designed to resist the erosion attack from the abrasive drilling fluid and solids. The lubricated and sealed joints include an elastomeric or hard plastic rolling seal boot that encloses the power transmission components of the joint. The seal boot keeps a lubricant within the joint and withholds the abrasive drilling fluid that flows along the outside of the boot from entering and attacking the enclosed power transmission components. The reliability of the seal boot is always a concern. The seal boot needs to handle cyclical loadings, including axial extension, axial compression, and lateral, angular, and torsional movement, as the rotor and driveshaft turn. The flexibility of the joints allows the driveshaft to transmit the rotational speed and torque through variable angles. When the seal boot cracks or tears, the lubricant will leak out and the drilling fluid will enter the joint, causing the components within the joint to be corroded and damaged. In general, a failure of seal boot on the driveshaft of a drilling motor can be classified as one or more of the following: fatigue failure caused by cyclical motion and poor design geometry; degradation of the seal due to chemical or abrasive attack by the drilling fluid; degradation of the seal under the high temperature and high pressure of the drilling fluid; bursting due to moisture expansion when the seal material is permeable to drilling fluid; bursting due to thermal expansion when the lubricant is degraded and a significant amount of pressurized gas is released from the lubricant; tearing when cut by a sharp-edged object in the drilling fluid; tearing and bursting when the boot is under influence of centrifugal forces; fatigue cracking when the wrong material (e.g., high stiffness) is used to manufacture the boot; and collapsing or bursting due to a pressure imbalance between the inside and outside of the seal boot's lubrication reservoir.

A seal boot for a drilling motor driveshaft configured for improved resistance to any or several of these failure modes would be advantageous to the industry.

In some instances, a conventional elastomeric or hard plastic seal boot cannot endure the aggressive drilling conditions that are present in some modem drilling operations. Therefore, examples of this disclosure relate to an enhanced seal boot to protect the joint from abrasive substances and operational strains that tend to weaken a seal boot. This disclosure relates generally to fabric reinforced seal elements for sealing joints to create a swelling-tolerant lubricated reservoir and for protecting a joint or threaded connection from an external abrasive environment. The inclusion of fabric reinforcement provides the joint seal element with improved resistance to tearing, expanding, or bursting under the influence of centrifugal forces when the seal boot is used in high-speed rotation applications.

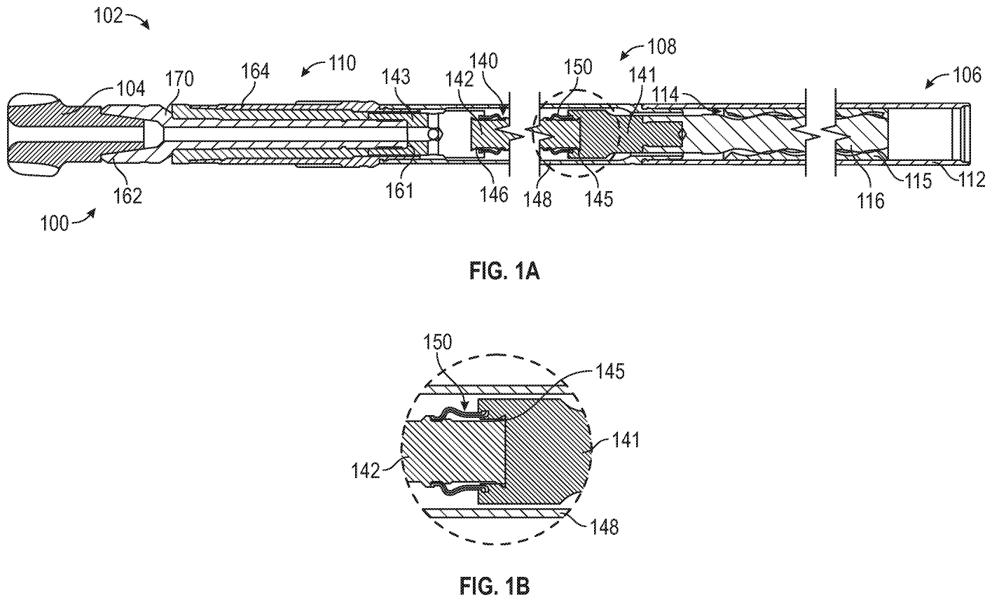

FIG. 1a shows a downhole drilling tool assembly 100 that includes a drilling motor 102 with a drill bit 104 attached. The drilling motor 102 and the drill bit 104 may form at least a portion of a bottom hole assembly (BHA) at the lower end of a drill string for creating or extending a wellbore. The drilling motor 102, which is an example of a downhole drilling tool, is configured to provide additional power to the drill bit 104 while drilling. The drilling motor 102 comprises a power section 106, a driveshaft assembly 108, and a bearing assembly 110.

The power section 106 includes a tubular housing 112 and a mud motor 114 having a stator 115 and a rotor 116 held in the housing 112. The power section 106 provides a wide range of rotational speeds and torque outputs to the drill bit 104. In an example, the rotational speed of the rotor 116 is proportional to the rate of drilling fluid passing through the power section 106, and the torque output is proportional to the differential pressure of that fluid. The power section 106 may be, for example, a progressive cavity positive displacement pump. When the drilling fluid is pumped through the power section 106, it creates an eccentric motion in the rotor 116 relative to the housing 112.

The driveshaft assembly 108 includes a driveshaft 140 having a first or upper member 141, a second or middle member 142, a third or lower member 143, and first and second lubricated and sealed joints 145, 146, respectively, enclosed in a housing 148. The joints 145, 146 may be universal joints, constant velocity joints, flex coupling, or other suitable coupling assemblies. In various embodiments, housing 148 is an adjustable bent-housing or fixed bent-housing, which connects to the housing 112 of the power section 106. In FIGS. 1a and 1b, the first and second joints 145, 146 are universal joints and are sealed by a generally tubular, fiber-reinforced joint seal element 150, which may also be referred to as a seal boot. In various examples, the seal boot 150 is flexible. The driveshaft 140 and its joints 145, 146 couple the rotor 116 to the bearing assembly 110. A first sealed joint 145 is located between the driveshaft 140 and the power section 106. A second seal joint 146 is located between the driveshaft 140 and the bearing assembly 110. The driveshaft assembly 108 functions as a transmission section to convert and transmit the eccentric power from the rotor 116 (e.g., relative to the housing 112) to concentric power in the bearing assembly 110 and, ultimately, in the drill bit 104. Facilitated by the joints 145, 146, the driveshaft assembly 108 adapts to any angle that is set or established in the adjustable/fixed bent-housing 148 and transmits the thrust load from the rotor 116 that is generated by the pressure drop across the power section 106. The driveshaft assembly 108 is designed to withstand the torque developed by the power section 106.

The tubular bearing assembly 110 extends from an upper end 161 to a lower end 162 and consists of a housing 164, and tubular mandrel 170. The mandrel 170 extends from the upper end 161 to the lower end 162. At the upper end 161, mandrel 170 is configured to couple to driveshaft lower member 143. At the lower end 162, the mandrel 170 is configured to couple to the drill bit 104.

Bearing assembly 110 is configured to transmit the rotation of the driveshaft assembly 108 to the drill bit. The bearing assembly 110 is designed to carry the thrust load from the weight of the collars that may be located above it on a drill string, as well as the radial and bending loads that develop during directional or steerable drilling.

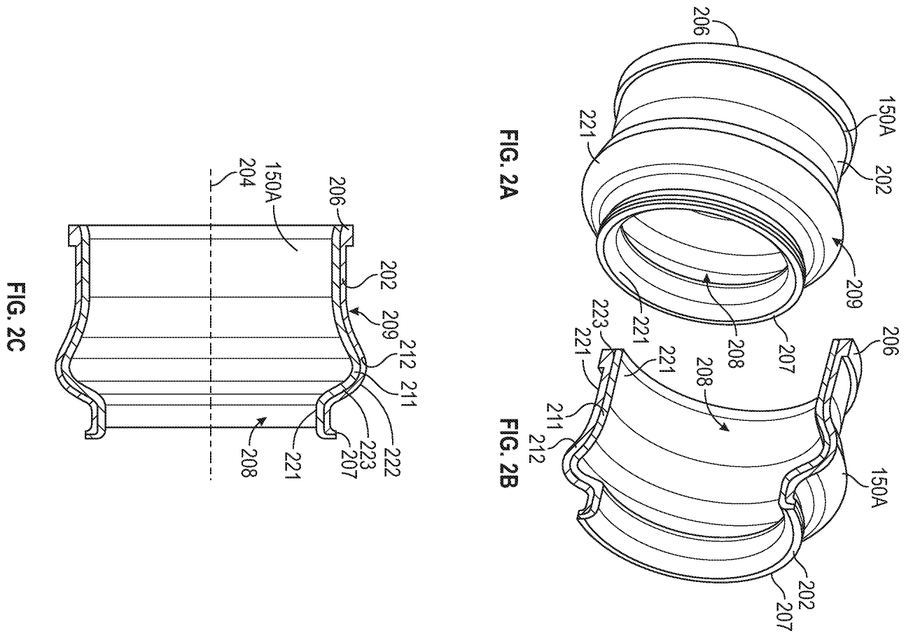

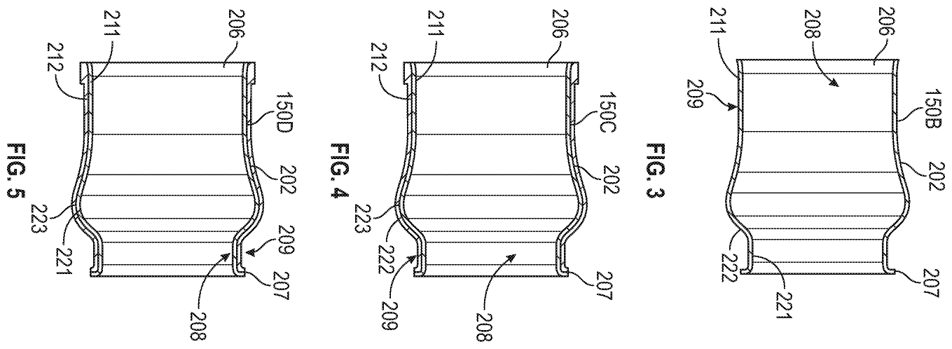

FIGS. 2a-2c and 3-8 show examples of fiber reinforced seal elements, which are flexible seal boots 150A to 150G. Any of these boots, or combinations thereof, may be included in the motor assembly 102 of FIG. 1 as an embodiment of the seal element 150. Some characteristics of the embodiments of FIGS. 2a-2c and 3-8 are described in the “Brief Description of the Drawings” section, above and are described below. In these examples, the seal boots 150 have a cross-sectional shape that varies in diameter and includes a bulge or bellow portion disposed axially between the ends of boots 150. The seal boots include sealing features, including surface regions or shoulders, to seal against regions or surfaces on the joints that they are configured to seal. In the example shown in FIG. 1, the joints 145, 146 at the end of the driveshaft 140 have a larger diameter than the seal boots 150. In various embodiments, the seal boots 150 are sufficiently flexible to be expanded in diameter to slide over the joint 145, 146 at the end of the driveshaft 140.

In various embodiments, seal boots 150 that are made accordance with principles described herein may include any of several configurations of fabric or fiber cloth to perform as a fabric reinforcement element. Examples of the present disclosure may utilize various fabric configurations. For example, a fabric reinforcement element for the present disclosure can be constructed as a 1-dimensional element (roving yarn), as a 2-dimensional element (chopped strand mat, pre-impregnation sheet, plain weave, tri-axial weave, and multi-axial weave), and as a 3-dimensional element (3D solid braiding, multiply weave, tri-axial 3D weave, multiaxial 3D weave, laminate, beam, and honeycomb). The fabric reinforcement elements are textile material woven with high performance structural fibers which can be made of polyester, nylon, aramid (trade names Kevlar® and Twaron®), liquid crystal polymer (trade names Vectran™), fiberglass, carbon filament, metal wire, olefin polymer, polyvinylidene fluoride (PVDF), polytetrafluoroethylene (PTFE), or expanded polytetrafluoroethylene (ePTFE), as examples. In some examples, the reinforced seal boots 150 include a first type of fabric with a second type of fabric added as a reinforcement element.

In various embodiments, fabric reinforcement elements described herein for seal boots 150 are designed to reduce the permeable rate of drilling fluid through the seal boot 150, to increase the tear resistance of the seal boot 150, to extend the fatigue lifecycle of the seal boot 150 from various movements, and to hold the shape of the seal boot 150 when a pressure imbalance occurs across the seal boot 150 or in response to centrifugal forces during high rotational speed.

Referring again to FIGS. 2a, 2b, and 2c, a triple-ply fabric reinforced seal boot 150A is shown. Boot 150A has three, spaced-apart plies, which may also be called layers or sheets, of fabric bonded to body material. Boot 150A includes a tubular body 202 that extends along a sleeve axis 204 between a first end 206 and a second end 207 and extends radially between a first or inner surface 208 and a second or outer surface 209 of boot body 202. Body 202 is formed from a first or inner body layer 211 bonded to a first or inner fabric layer 221, which is disposed at the inner surface 208, a second or outer body layer 212 bonded to a second or outer fabric layer 222, which is disposed at the outer surface 209, and a third or mid-region fabric layer 223 bonded to and disposed radially between body layers 211, 212. A fabric layer may also be called a fabric ply. Fabric layer 223 is located in the mid-region of the wall thickness of boot body 202 in boot 150A. In general, body layers 211, 212 may have the same or different thickness, causing mid-region fabric layer 223 to be disposed/located equally between fabric layers 221, 222 or to be disposed closer to either of those fabric layers 221, 222.

Outer fabric layer 222 is disposed radially opposite the inner fabric layer 221. Separated by the inner body layer 211, the mid-region fabric layer 223 is disposed radially opposite the inner fabric layer 221 and, separated by the outer body layer 212, the fabric layer 223 is disposed radially opposite the outer fabric layer 222. In general, body layers 211, 212 and fabric layers 221, 222, 223 are stacked radially and extend axially between ends 206, 207.

An outer ply of fabric, such as fabric layer 222, serves particularly as a protection layer to withstand the abrasive and sharp solids in drilling fluid flowing over the seal boot 150 or to increase the chemical resistance of the seal boot 150. The inner ply of fabric 221 contains a lubricant within the seal boot 150 and lowers the degradation rate of seal boot 150 that might otherwise result from contact with the lubricant. A ply of fabric located in the mid-region of the radial thickness of a boot, such as fabric layer 223, is configured as a backup protection layer and to function like the inner and/or outer layer 221, 222 when the inner or outer layer 221, 222 is damaged. In various embodiments, the multiple fabric layers of a boot 150 (e.g., layers 221, 222, 223 of boot 150A) include the same type of material and the same fabric configurations, such as type of weave, thickness, fiber diameter, and the like. In some embodiments, a fabric layer of a boot 150 includes a different material or a different fabric configuration than another layer of the boot 150.

Referring again to FIGS. 2a, 2b, and 2c, the body layers of a boot 150 (e.g., layers 211, 212 of boot 150A) are fabricated from moldable body material. In various embodiments, the body material for a body layer 211, 212 includes plastic material or elastomeric material, as examples. In various embodiments, the multiple body layers 211, 212 include the same body material. In other embodiments, a body layer 211 includes a different body material than another body layer 212. In general, elastomeric material is flexible and resilient to a degree. Some plastic material is semi-rigid yet flexible, but such plastics may be less flexible than the elastomeric material. In various embodiments, the materials of body layers or fabric layers are selected for chemical resistance to various fluids, for greater tensile strength, for abrasion resistance to increase tolerance to drilling mud, oils, or other moving fluids, or for another engineering purpose.

FIG. 3 shows a double-ply fabric reinforced seal boot 150B having first and second, spaced-apart layers or sheets of fiber bonded with body material. In its various embodiments, boot 150B includes the same features and characteristics as boot 150A, except boot 150B lacks the second body layer 212 and lacks the mid-region fabric layers 223. For example, boot 150B includes a tubular body 202 that extends axially between first and second ends 206, 207 and extends radially between an inner surface 208 and an outer surface 209. Body 202 is formed from a body layer 211 bonded to a first or inner fabric layer 221, which is disposed at the inner surface 208, and bonded to a second or outer fabric layer 222, which is disposed at the outer surface 209. Outer fabric layer 222 is disposed radially opposite the inner fabric layer 221.

FIG. 4 shows a double-ply fabric reinforced seal boot 150C having first and second, spaced-apart fiber layers or sheets 222, 223, which are bonded at its outer surface 209 and within its body's wall thickness. In its various embodiments, boot 150C includes the same features and characteristics as boot 150A, except boot 150C lacks the inner fabric layer 221. For example, boot 150C includes a tubular body 202 that extends axially between first and second ends 206, 207 and extends radially between an inner surface 208 and an outer surface 209. Body 202 is formed from a first or inner body layer 211, a second or outer body layer 212, a first or outer fabric layer 222 bonded to body layer 212 and disposed at the outer surface 209, and a second or mid-region fabric layer 223 bonded to and disposed radially between body layers 211, 212.

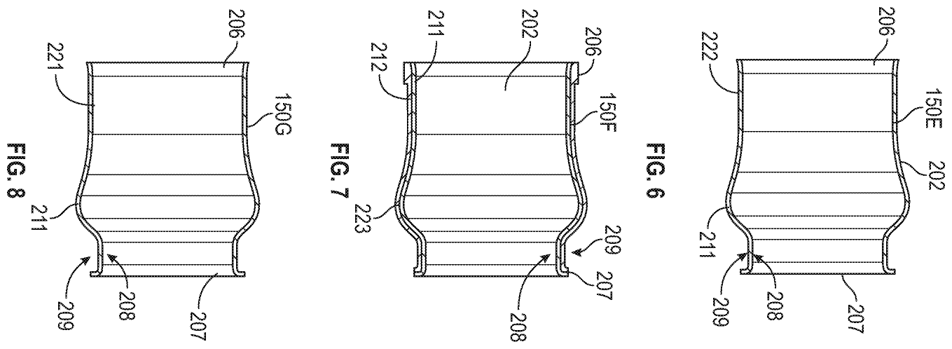

FIG. 5 shows a double-ply fabric reinforced seal boot 150D having first and second, spaced-apart fiber layers or sheets 221, 223, which are bonded at its inner surface 208 and within its body's wall thickness. In its various embodiments, boot 150D includes the same features and characteristics as boot 150A, except boot 150D lacks the outer fabric layer 222. For example, boot 150D includes a tubular body 202 that extends axially between first and second ends 206, 207 and extends radially between an inner surface 208 and an outer surface 209. Body 202 is formed from a first or inner body layer 211, a second or outer body layer 212, a first or inner fabric layer 221 bonded to body layer 211 and disposed at the inner surface 208, and a second or mid-region fabric layer 223 bonded to and disposed radially between body layers 211, 212.

FIG. 6 shows a single-ply fabric reinforced seal boot 150E having a layer or sheet of fabric bonded at its outer surface 209. In its various embodiments, boot 150E includes the same features and characteristics as boot 150A, except boot 150E lacks the second body layer 212 and lacks the inner and mid-region fabric layers 221, 223. For example, boot 150E includes a tubular body 202 that extends axially between first and second ends 206, 207 and extends radially between an inner surface 208 and an outer surface 209. Body 202 is formed from a body layer 211 bonded to an outer fabric layer 222, which is disposed at the outer surface 209.

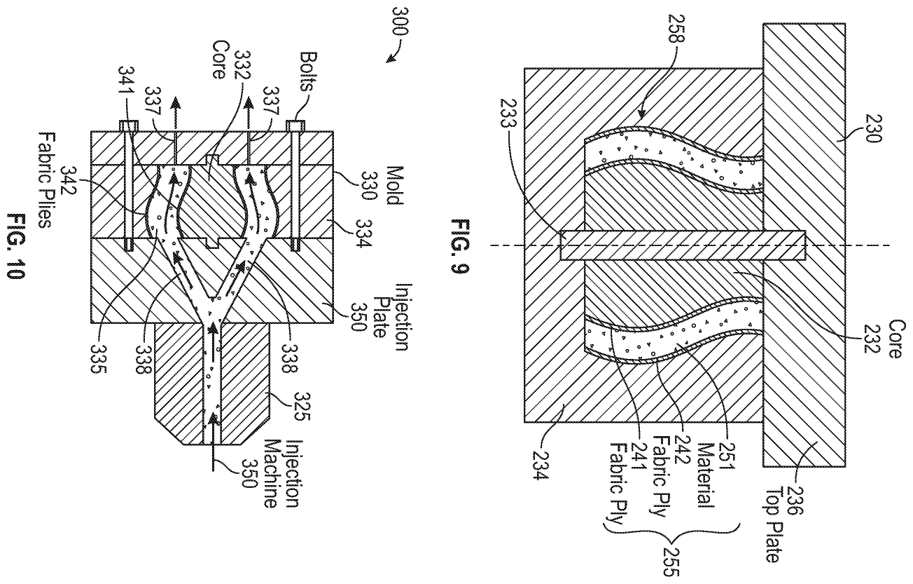

FIG. 7 shows a single-ply fabric reinforced seal boot 150F having a layer or sheet of fabric 223 bonded within body material 211, 212. In its various embodiments, boot 150F includes the same features and characteristics as boot 150A, except boot 150F lacks an inner fabric layer 221 and an outer fabric layer 222. For example, boot 150F includes a tubular body 202 that extends axially between first and second ends 206, 207 and extends radially between an inner surface 208 and an outer surface 209. Body 202 is formed from a first or inner body layer 211, a second or outer body layer 212, and a first or mid-region fabric layer 223 bonded to and disposed radially between body layers 211, 212. The body layers 211, 212 of boot 150F include the same body material, which may include plastic material or elastomeric material, as examples.

FIG. 8 shows a single-ply fabric reinforced seal boot 150G having a layer or sheet of fabric 221 bonded to body material 211. In its various embodiments, boot 150G includes the same features and characteristics as boot 150A, except boot 150G lacks the second body layer 212 and lacks the outer and mid-region fabric layers 222, 223. For example, boot 150G includes a tubular body 202 that extends axially between first and second ends 206, 207 and extends radially between an inner surface 208 and an outer surface 209. Body 202 is formed from a body layer 211 bonded to an inner fabric layer 221, which is disposed at the inner surface 208.

In accordance with principles described herein, embodiments of seal boot 150 include a layer of fabric bonded to a layer of body material. Some embodiments of seal boot 150 include multiple, spaced-apart layers of fabric bonded to a layer of body material or bonded to multiple, spaced-apart layers of body material, such as layers 211, 212. In some embodiments, an inner fabric layer 221 is embedded within the adjoining layer of body material, such that the body material forms a portion or all of inner surface 208. In some embodiments, an outer fabric layer 222 is embedded within the adjoining layer of body material, such that the body material forms a portion or all of outer surface 209.

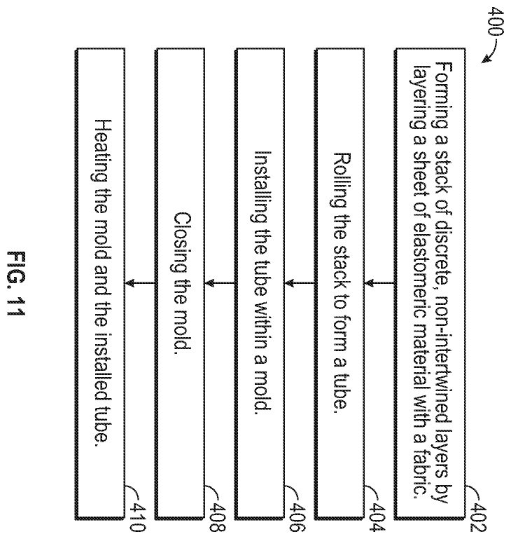

Multiple methods can be used to fabricate a fiber reinforced seal element in accordance with principles described herein. These methods can be used to fabricate the various embodiments of flexible seal boot 150 shown in FIGS. 1-8. For convenience, the description of these methods will refer to seal boot 150 or to a specific embodiment as an example. Both compression molding (FIG. 9) and injection molding (FIG. 10) can be used to manufacture the fabric reinforced seal boots disclosed herein. These method examples each show the fabrication of a double-ply fiber reinforced seal element having an inner and an outer fabric layer bonded with body material between them, such as boot 150B of FIG. 3.

In FIG. 9, a mold 230 is used for compression molding of a fiber reinforced seal element 150. Mold 230 includes a mold core 232 having a central axle 233, a base mold 234, and a top plate 236. Base mold 234 may include multiple, separable pieces to facilitate installation of materials or removal of the completed seal element 150. Fabrication of seal element 150 includes placing a first fabric layer 241 and a second fabric layer 242 separated by a sheet of body material 251, such as an elastomeric material or a plastic, forming a stack 255 of discrete, non-intertwined layers. A bonding agent may be applied between a fabric layer 241, 242 and the body layer 251 to adhere and adjoin them before installing them in the mold. The stack 255 is rolled on to the mold core 232 about central axle 233, forming a core assembly 258. The axial length of stack 255 may be greater than the axial length of core 232 to insure adequate filling of the mold 235 to achieve adequate compression of stack 255. The core assembly 258 is placed in the base mold 234. The base mold 234 is covered by the top plate 236, compressing the stack 255. Then, the entire mold assembly (i.e., mold 230 with stack 255 inside) will be heated in an oven to cure the body material 251 as well as the bonding agent that is disposed between the fabric and body layers, 241, 241, 251 forming seal element 150. The embodiments of the seal boots 150A to 150G of FIGS. 2a-2c and 3-8 may be fabricated using the method depicted in FIG. 9.

FIG. 10 shows an injection molding system 300 for fabricating a fiber reinforced seal element, including at least some embodiments of seal boot 150. The current example shows a process for fabricating a double-ply fabric reinforced element having first and second, spaced-apart fiber layers bonded on the inside and outside surfaces of body material. System 300 includes an injection machine 325 coupled to a mold 330. Mold 330 includes a mold core 332 having a central axle 333, a base mold 334, and a top plate or injection plate 336. Base mold 334 includes a chamber 335 configured to form a seal element and includes a plurality of bleed or vent ports 337 fluidically coupled to chamber 335 and spaced-apart from injection plate 336. Base mold 334 may include multiple, separable pieces to facilitate installation or removal of materials or the completed seal element. Plate 336 includes an injection manifold having multiple channels or ports 338 fluidically coupled with chamber 335 and injection machine 325. Injection machine 325 is configured to be fluidically coupled with ports 338, as is depicted in FIG. 10.

Fabrication of the seal element using molding system 300 includes placing a first fabric layer 341 around the mold core 332, and placing a second fabric layer 342 along an inner surface of base mold 334. Ends of fabric layers 341, 342 may be held or gripped between base mold 334 and plate 336, or elsewhere inside the mold 330, in order to maintain the position of layers 341, 342 during the injection process. Prior to installation of layers 341, 342 or prior injection, a bonding agent, which may include a wetting agent, may be applied to a fabric layer 341, 342 to cause an injected material to adhere to a fabric layer 341, 342 more effectively. Subsequent to the installation of layers 341, 342, injection machine 325 injects body material 350, such as an elastomeric material or a plastic, in a melted, a mixed, or an otherwise flowable liquid state into mold 330 through ports 338 in injection plate 336. The body material is injected by injection machine 325 with a selected pressure and temperature to fill the mold 330. After mold 330 is filled, which may be indicated by body material 350 flowing from the mold through vents 337, the entire mold assembly 330 is to be heated in an oven to cure the body material as well as any bonding agent that may be disposed between fabric plies and body material. After cooling, the fiber reinforced seal element is removed from mold 330. At least the embodiments of the seal boots 150B, 150E, and 150G of FIGS. 3, 6, and 8 may be fabricated using the system and method depicted in FIG. 10.

In order to provide resistance to chemical attack either from lubricants or drilling fluid, an elastomeric compatible protective coating, such as Hypalons® (a registered trademark of E. I. DuPont de Nemours Co.) and Neoprenes® (a registered trademark of E. I. DuPont de Nemours & Co.) may be applied to an inner surface or an outer surface that lacks a fiber layer on various embodiments of fiber reinforced seal elements. In some examples, the protective coating is applied after the seal element is structurally formed, for example after being formed in a mold and cured. As examples, a protective coating may be applied on the inner surface 208 of a seal boot 150C, 150E in FIG. 4 and FIG. 6, on the outer surface 209 of seal boot 150D, 150G in FIG. 5 and FIG. 8, or on both inner and outer surfaces 208, 209 of seal boot 150F as shown in FIG. 7. The protective coating may increase strength, fatigue resistance, ozone/ultraviolet resistance, and environmental protection. This protective coating can be applied through spraying, dipping, and brushing, as examples. After application, the protective coating becomes a member of or defines the respective inner or outer surface 208, 209 where it is disposed. Some embodiments may include a protective coating applied to a surface 208, 209 that includes a fiber layer 221, 223.

FIG. 11 shows a method 400 for fabricating a flexible reinforced seal element such as embodiments of seal boot 150 in accordance with the principles described herein. Method 400 may be applied, for example, to the operation of compression mold 230 in FIG. 9. Continuing to reference FIG. 11, at block 402, the method 400 includes forming a stack of discrete, non-intertwined layers by layering a sheet of elastomeric material with a fabric. Block 404 includes rolling the stack to form a tube. Block 406 includes installing the tube within a mold. Block 408 includes closing the mold. Block 410 includes heating the mold and the installed tube.

In some examples, rolling the stack of discrete layers to form a tube in Block 404 includes overlapping opposite edges of the stack. In some examples, the sheet of elastomeric material is rubber and is pre-cured before being layered with a fabric. Some examples of the method 400 further include causing the tube to be compressed. After curing, the heated mold is cooled by ambient air or a water quenching process, as examples, and the mold is opened and disassembled. Excess elastomeric flash and fabric cloth may be trimmed carefully to prevent gouging on the part, i.e. the cured seal element. Various embodiments of the method 400 may include fewer operations than described, and other embodiments of the method 400 may include additional operations based on other concepts disclosed in this specification, including the figures. Although the method 400 is described for an elastomeric material, the method 400 is also applicable to a seal element formed form sheets of plastic material.

While exemplary embodiments have been shown and described, modifications thereof can be made by one of ordinary skill in the art without departing from the scope or teachings herein. The embodiments described herein are exemplary only and are not limiting. Many variations, combinations, and modifications of the systems, apparatuses, and processes described herein are possible and are within the scope of the disclosure. Accordingly, the scope of protection is not limited to the embodiments described herein, but is only limited by the claims that follow, the scope of which shall include all equivalents of the subject matter of the claims. The inclusion of any particular method step or operation within the written description or a figure does not necessarily mean that the particular step or operation is necessary to the method. The steps or operations of a method listed in the specification or the claims may be performed in any feasible order, except for those particular steps or operations, if any, for which a sequence is expressly stated. In some implementations two or more of the method steps or operations may be performed in parallel, rather than serially.

What is claimed is:

1. A method for forming a seal boot, the method comprising:
forming a stack of discrete, non-intertwined layers by layering a sheet of elastomeric material with a fabric;
rolling the stack to form a tube;
installing the tube within a mold;
closing the mold; and
heating the mold and the installed tube.

2. The method of claim 1, wherein rolling the stack of discrete layers to form a tube includes overlapping opposite edges of the stack.

3. The method of claim 1, wherein the sheet of elastomeric material is rubber and is pre-cured before being layered with a fabric.

4. The method of claim 1, further comprising: causing the tube to be compressed.

5. A seal boot for a rotatable joint of a downhole tool, the seal boot comprising:
a first body layer bonded to a first fabric layer, forming a generally tubular body that extends along a sleeve axis between a first end and a second end, and that extends radially between an inner surface and an outer surface;
wherein the seal boot is configured to cover the rotatable joint of the downhole tool.

6. The seal boot of claim 5, wherein:
the first fabric layer is disposed at the inner surface; and
the seal boot further comprises a second fabric layer disposed at the outer surface.

7. The seal boot of claim 5, wherein:
the first fabric layer is disposed at the inner surface; and
the seal boot further comprises:
a second fabric layer disposed at the outer surface;
a second body layer bonded to the second fabric layer; and
a third fabric layer bonded to the second body layer radially opposite the second fabric layer and bonded to the first body layer radially opposite the first fabric layer.

8. The seal boot of claim 5, wherein first body layer is elastomeric or plastic or both

9. The seal boot of claim 5, wherein:
the first body layer extends from the inner surface radially outward to the first fabric layer;
the seal boot further comprises a second body layer extending from the first fabric layer radially outward to the outer surface; and
the first and second body layers comprise the same material.

10. The seal boot of claim 9, wherein the seal boot further comprises a second fabric layer disposed at the outer surface or at the inner surface.

11. The seal boot of claim 9, wherein the first and second body layers comprise plastic material.
